(19) United States
(12) Patent Application Publication
(10) Pub. No.: US 2005/0190661 A1
(43) Pub. Date: Sep. 1, 2005

(54) Counting device used in optical recording/reproducing apparatus

(75) Inventor: Jui-Chiang Lin, Hsinchu City (TW)

Correspondence Address: BIRCH STEWART KOLASCH & BIRCH, PO BOX 747, FALLS CHURCH, VA, 22040-0747, US

(73) Assignee: Lite-On It Corporation

(21) Appl. No.: 11/063,616

(22) Filed: Feb. 24, 2005

(30) Foreign Application Priority Data
Feb. 27, 2004 (TW) 93202950

(51) Int. Cl. G11B 7/085

(52) U.S. Cl. 369/30.27

(57) ABSTRACT

Disclosed is a counting device used in optical recording/reproducing apparatus, in which an optical storage media is directed into or moved away from the optical recording/reproducing apparatus via an opening thereof. In the optical recording/reproducing apparatus, the counting device comprises a sensor used to sense each entrance of the optical storage medium into the optical recording/reproducing apparatus through the opening and a counter used to count number of times of the entrances of the optical storage medium as sensed.

### BACKGROUND OF THE INVENTION

1. Field of Invention

The present invention relates to an optical recording/reproducing apparatus and particularly to a counter used in an optical recording/reproducing apparatus of slot-in type.

2. Related Art

With prevalence of optical storage media such as compact disks (CDs), optical recording/reproducing apparatus used for reading/writing data from/to the optical storage media also becomes widely commercially available. To satisfy different specifications of the optical storage media and user demands, a multitude of optical recording/reproducing apparatus such as CD-ROM, CD/RW, slot loading CD-ROM, COMBO CD-ROM, DVD-R/RW and external CD-ROM have been developed and come into the market.

To enable a user to take out/place an optical storage medium like a CD from/into an optical recording/reproducing apparatus and satisfy requirements of slightness and compactness of the apparatus, the slot loading CD-ROM may be a proper choice among the above mentioned optical recording/reproducing apparatus. Accordingly, the slot loading CD-ROM is generally employed as a playing apparatus for the CDs installed in such as a vehicle audio device and a note book computer.

FIG. 1 is a perspective view of a prior slot loading CD-ROM. FIG. 2 shows an internal structure of the prior slot loading CD-ROM. As shown, contrary to the other optical recording/reproducing apparatus, the slot loading CD-ROM 2 is not designed with a tray. That is, for the slot loading CD-ROM 2, a CD 4 is not directed thereto by means of the tray, but instead by means of a roller 6.

Referring to FIG. 3, a side cross-sectional view of the prior slot loading CD-ROM 2 with the roller 6 is depicted therein. When a CD 4 is directed into the slot loading CD-ROM 2 through an opening thereof, the CD 4 contacts the roller 6 of the CD-ROM 2 at a side surface of its front end (a lower-side surface in FIG. 3). When the CD 4 is detected, the roller 6 rotates and the CD 4 contacted with the roller 6 is ejected from the slot loading CD-ROM 2.

Although the recording/reproducing CD-ROMs may perform recording and reproducing functions with respect to data in the CDs, they may have their limited lifetime. Typically, the lifetime of the recording/reproducing CD-ROM may be roughly measured by number of times of execution of the recording and reproducing operations.

However, a user of the CD-ROM may not monitor and perceive a current state of the CD-ROM, i.e. the user may not know how many times of execution of the recording and reproducing operations may be conducted. Particularly in the case that a slot loading CD-ROM is carried away from home or office environments, if the CD-ROM gets into a failure, there would be no action to be taken in an attempt to obtain data stored in the CDs which is not like the case that a desktop computer having the CD-ROM is used that has other solutions to be resorted to. If the remained lifetime of the CD-ROM may be known at any time, the user thereof may prepare a new CD-ROM for replacement at a time before the used CD-ROM has a failure occurred and thus a currently computer-performed task may not be broken off due to the failure. Further, the remained lifetime of the CD-ROM may be taken as a reference in determining a price of this second-hand CD-ROM.

In light of the above, there is a need created to provide a counting device in an optical recording/reproducing apparatus and particularly in a slot loading CD-ROM.

### SUMMARY OF THE INVENTION

It is, therefore, an object of the present invention to provide a counting device used in an optical recording/reproducing apparatus, particularly in a slot loading CD-ROM, in which an optical storage media is directed into or moved away from the optical recording/reproducing apparatus via an opening thereof. In the optical recording/reproducing apparatus, the counting device comprises a sensor used to sense each entrance of the optical storage medium into the optical recording/reproducing apparatus through the opening and a counter used to count number of times of the entrances of the optical storage medium as sensed.

The slot loading CD-ROM further comprises a roller used to move the optical storage medium contacted with the roller so that the optical storage medium is directed into the slot loading CD-ROM. The sensor is used to sense the roller being driven and the counter is used to count the number of times of the entrances of the optical storage medium into the optical recording/reproducing apparatus by accumulating the number of times of being driven of the roller as sensed.

The slot loading CD-ROM further comprises a drive motor used to drive the roller to rotate and the counter counts the number of the entrances of the optical storage medium into the optical recording/reproducing apparatus by accumulating the number of times of the roller being driven as sensed.

The optical recording/reproducing apparatus also comprises an eject button used to move the optical storage medium away from the optical recording/reproducing apparatus upon being pressed. The sensor is used to sense the eject button being pressed and the counter counts the number of times of entrances of the optical storage medium into the optical recording/reproducing apparatus by accumulating the number of times of the eject button being pressed as sensed.

Furthermore, the counter also comprises a memory used to store the number of times of the entrances of the optical storage medium into the recording/reproducing apparatus accumulated by the counter and a display used to display the number of times of the entrances of the optical storage medium into the recording/reproducing apparatus accumulated by the counter.

With the counting device in the inventive optical recording/reproducing, therefore, number of times of entrances of the optical storage medium into the optical recording/reproducing apparatus such as the slot-loading CD-ROM may be accumulated. Accordingly, the number of times of operations of the CD-ROM may be roughly perceived and remained lifetime of the CD-ROM may be known at any time based thereon, the user of the CD-ROM may prepare a new CD-ROM for replacement at a time before the used CD-ROM has a failure occurred and thus a currently computer-performed task may not be broken off due to the failure. Further, the remained lifetime of the CD-ROM may be taken as a reference in determining a price of this second-hand CD-ROM.

In light of the above, there is a need created to provide a counting device in an optical recording/reproducing apparatus and particularly in a slot loading CD-ROM.

### BRIEF DESCRIPTION OF THE DRAWINGS

The invention will become more fully understood from the detailed description given hereinbelow illustration only, and thus are not limitative of the present invention, and wherein:

FIG. 1 is a perspective view of a prior slot loading CD-ROM;

FIG. 2 is an internal structure of the prior slot loading CD-ROM;

FIG. 3 is a side cross-sectional view of the prior slot loading CD-ROM with a roller;

FIG. 4 is a schematic diagram of a slot loading CD-ROM according to the present invention;

FIG. 5 is a schematic diagram of a counting device used in the slot loading CD-ROM according to the present invention;

FIG. 6A is a schematic diagram of a sensor of a first embodiment used in the slot loading CD-ROM according to the present invention;

FIG. 6B is a schematic diagram of the sensor of a second embodiment used in the slot loading CD-ROM according to the present invention;

FIG. 6C is a schematic diagram of the sensor of a third embodiment used in the slot loading CD-ROM according to the present invention;

FIG. 7A is a schematic diagram of a switch used in the slot loading CD-ROM according to the present invention;

FIG. 7B is a schematic diagram of the sensor of a forth embodiment used in the slot loading CD-ROM according to the present invention; and

FIG. 8 is a schematic diagram of the counter used in the slot loading CD-ROM according to the present invention.

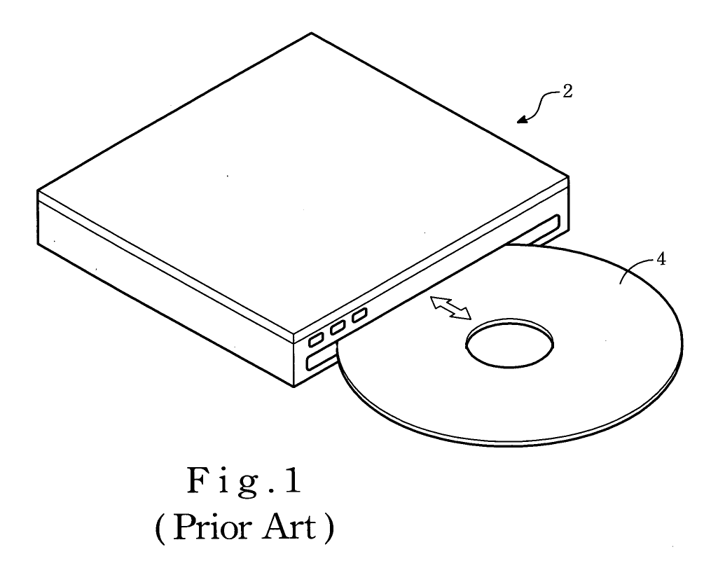

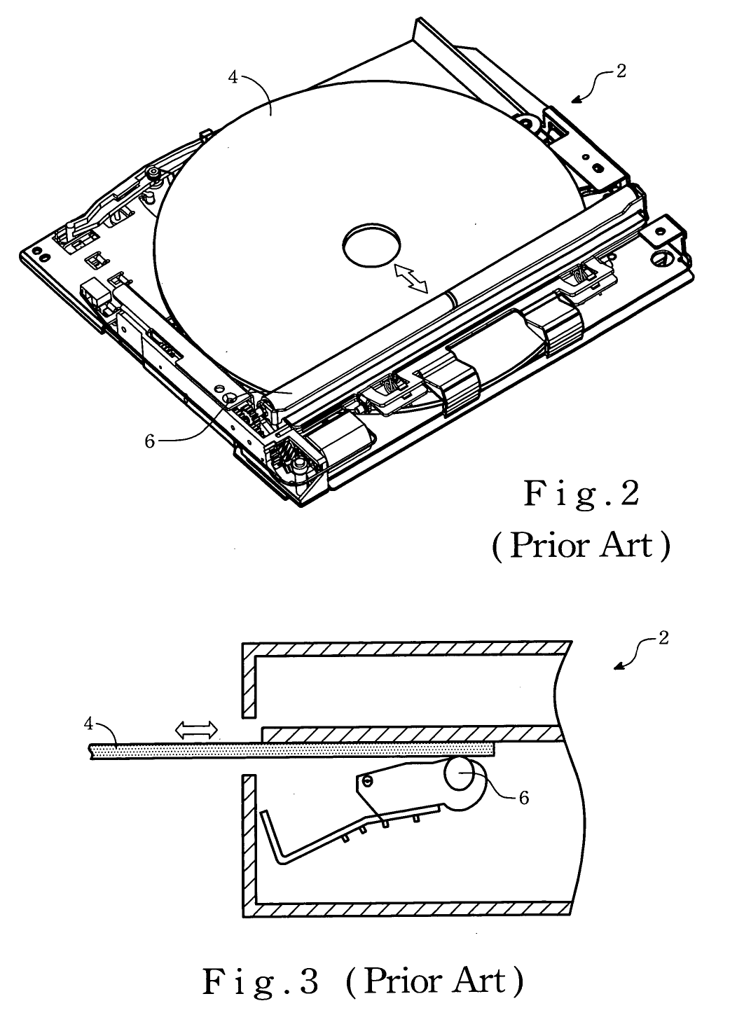

### DETAILED DESCRIPTION OF THE INVENTION

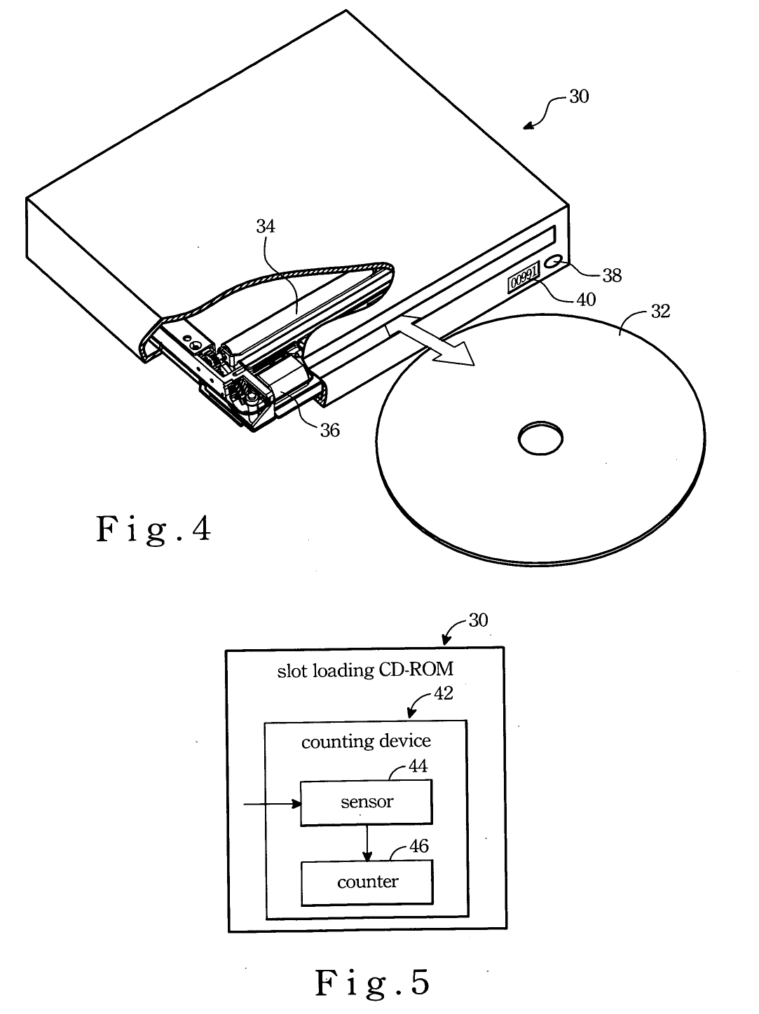

Referring to FIG. 4, a slot loading CD-ROM according to the present invention is schematically depicted therein. The slot loading CD-ROM 30 comprises a roller 34 which is the same as that described in the section of prior art, a drive motor 36, an eject button 38 and a counting device. Although only a display 40 of the counter can be seen in FIG. 4, the other components are de facto present and will be shown in FIG. 5. In addition, although the specific slot loading CD-ROM is described and explained, other recording/reproducing apparatus may also be used in the present invention.

An optical storage medium such as a compact disk (CD) 32 may be directed into the slot loading CD-ROM 30 through an opening thereof. When the roller 34 contacts with the CD 32, the drive motor 36 drives the roller 34 to rotate and cause the CD 32 contacted with the roller 34 to be moved so that the CD 32 may enters or exits the CD-ROM 30. The CD 32 may also be moved away from the CD-ROM 30. At this time, a user of the CD-ROM 30 may press the eject button 38 to cause the CD 32 to be moved away from the slot loading CD-ROM 30.

Referring now to FIG. 5, a counting device 42 is shown and provided to count number of times of entrances of the CD 32 into the slot loading CD-ROM 30. The counting device 42 comprises a sensor 44 and a counter 46. The sensor 44 is used to sense entrances of the CD 32 into the slot loading CD-ROM 30. The counter 46 is used to count the number of times of the entrances of the CD 32 into the slot loading CD-ROM 30 sensed by the sensor 44.

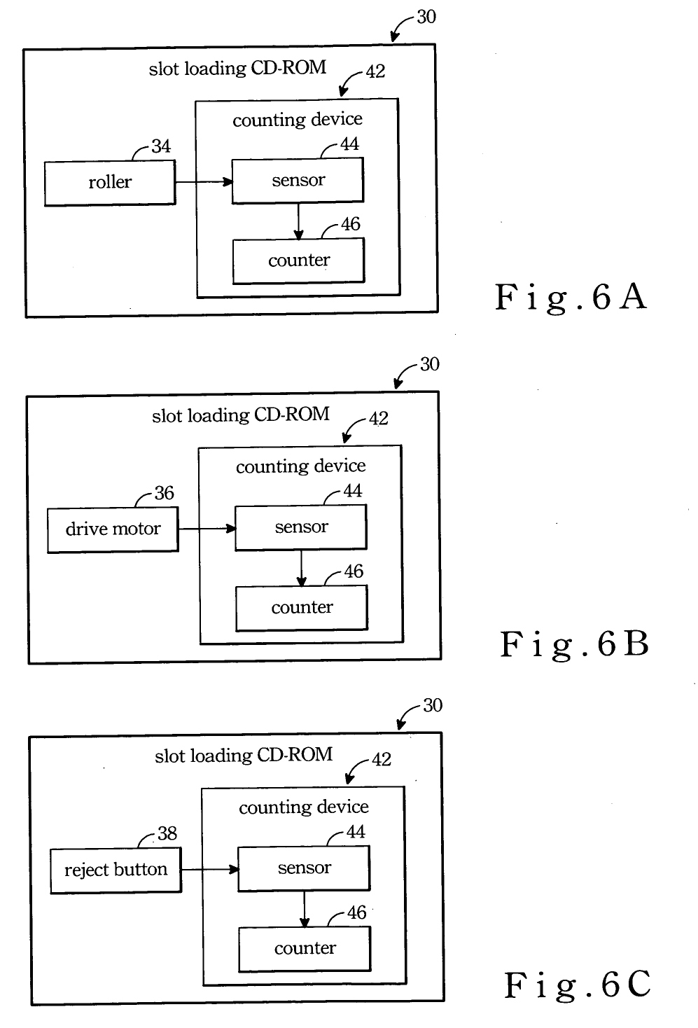

Specifically, the sensor 44 may sense the entrances of the CD 32 into the slot loading CD-ROM 30 in different mechanism. Referring to FIG. 6A, the sensor 44 of a first embodiment used in the slot loading CD-ROM according to the present invention is schematically depicted therein. In this embodiment, the sensor 44 is used to sense the roller 34 being driven and the counter 46 is then used to count the number of times of the entrances of the CD 32 into the slot loading CD-ROM 30 by accumulating the number of times of the roller 34 being driven as sensed.

Referring to FIG. 6B, the sensor of a second embodiment used in the slot loading CD-ROM according to the present invention is schematically depicted therein. In this embodiment, the sensor 44 is used to sense a motor, as mentioned above, driving the roller 34 and the counter 46 is then used to count number of times of entrances of the CD 32 into the slot loading CD-ROM 30 by accumulating the number of times of the motor being driven as sensed.

Referring to FIG. 6C, the sensor of a third embodiment used in the slot loading CD-ROM according to the present invention is schematically depicted therein. In this embodiment, the sensor 44 is used to sense the eject button 38 being pressed and the counter 46 is then used to count number of times of entrances of the CD 32 into the slot loading CD-ROM 30 by accumulating the number of times of the eject button 38 being pressed as sensed.

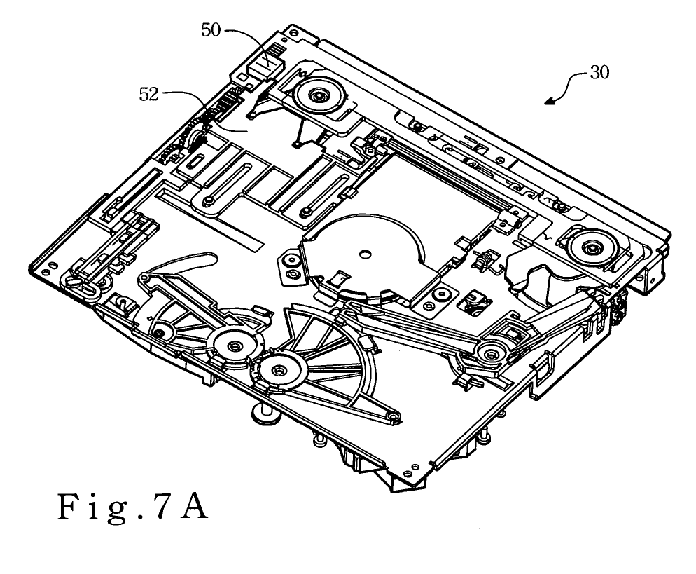

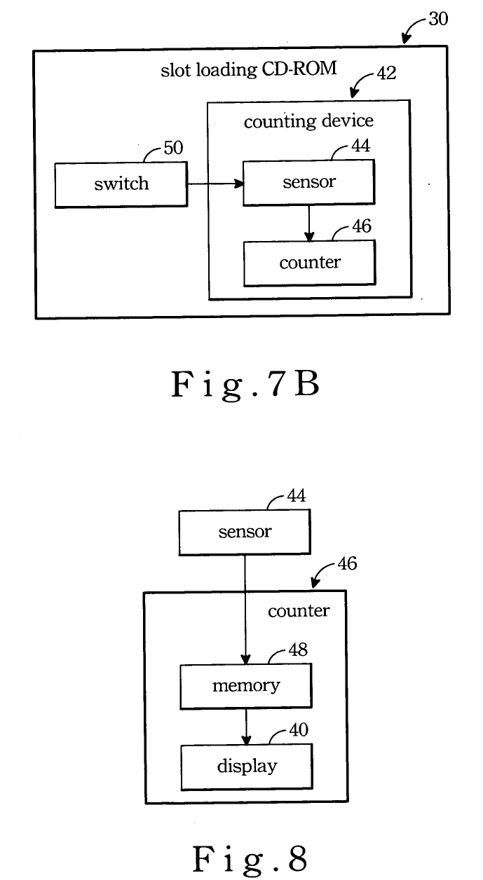

Referring to FIG. 7A, a switch 50 used in the slot loading CD-ROM according to the present invention is schematically depicted therein. In the slot loading CD-ROM as described above, a switch 50 and a slide member 52 are further comprised. After the CD 32 is directed into or moved away from the CD-ROM 30, the switch 50 is triggered by the slide member 52 to stop the moving of the CD 32 into or away from the CD-ROM 30.

Referring to FIG. 7B, the sensor 44 of a fourth embodiment according to the present invention is schematically depicted therein. In this embodiment, the sensor 44 is used to sense the switch 50 being triggered and the counter 46 counts number of times of entrances and exits of the CD 32 into and from the slot loading CD-ROM 30 respectively by accumulating the number of times of the switch 50 being triggered as sensed.

Reference is now made to FIG. 8, the counter used in the slot loading CD-ROM is depicted schematically therein. The counter 46 comprises a memory 48 and a display 40 (alluded in FIG. 4). In this embodiment, the number of times of the entrances of the CD 32 into the slot loading CD-ROM 30 as obtained above is stored in the memory 48 and displayed on the display 46.

As alluded above, the countering mechanism provided in this invention may not only used in the slot loading CD-ROM 30 described above, but may also be used in optical recording/reproducing apparatus of any kind which may be configured with the sensor 44 and other components as mentioned above and operate in the similar manner.

Therefore, number of times of entrances of the optical storage medium 32 into the recording/reproducing apparatus 30 of the present invention may be counted. Therefore, the user of the CD-ROM may perceive the remained lifetime thereof through the number of times of the entrances of the optical storage medium 32 so that the user may prepare a new CD-ROM for replacement at a time before the used CD-ROM has a failure occurred and thus a currently computer-performed task may not be broken off due to the failure. Further, the remained lifetime of the CD-ROM may be taken as a reference in determining a price of this second-hand CD-ROM.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims and their equivalents.

1. A counting device used in an optical recording/reproducing apparatus where an optical storage medium is directed into or moved away through an opening of the optical recording/reproducing apparatus and number of times of entrances of the optical storage medium into the optical recording/reproducing apparatus is counted by the counting device, the counting device comprises:
a sensor used to sense each entrance of the optical storage medium into the optical recording/reproducing apparatus; and
a counter configured to count the number of times of the entrances of the optical storage medium into the recording/reproducing apparatus by accumulating the number of times of the entrances of the optical storage medium as sensed.

2. The counting device as recited in claim 1, wherein the optical recording/reproducing apparatus is a slot loading CD-ROM.

3. The counting device as recited in claim 2, wherein the slot loading CD-ROM comprises a roller used to move the optical storage medium contacted with the roller so that the optical storage medium is directed into the slot loading CD-ROM.

4. The counting device as recited in claim 3, wherein the sensor is used to sense the roller being driven and the counter is used to count the number of times of the entrances of the optical storage medium into the optical recording/reproducing apparatus by accumulating the number of times of being driven of the roller as sensed.

5. The counting device as recited in claim 3, wherein the slot loading CD-ROM further comprises a drive motor used to drive the roller to rotate and the counter counts the number of the entrances of the optical storage medium into the optical recording/reproducing apparatus by accumulating the number of times of the roller being driven as sensed.

6. The counting device as recited in claim 1, wherein the optical recording/reproducing apparatus comprises an eject button used to move the optical storage medium away from the optical recording/reproducing apparatus upon being pressed.

7. The counting device as recited in claim 6, wherein the sensor is used to sense the eject button being pressed and the counter counts the number of times of entrances of the optical storage medium into the optical recording/reproducing apparatus by accumulating the number of times of the eject button being pressed as sensed.

8. The counting device as recited in claim 1, wherein the sensor is used to sense a switch and the counter counts the number of times of the entrances of the optical storage medium into the optical recording/reproducing apparatus by accumulating the number of times of the eject button being pressed as sensed.

9. The counting device as recited in claim 1, wherein the counter comprising a memory used to store the number of times of the entrances of the optical storage medium into the recording/reproducing apparatus accumulated by the counter.

10. The counting device as recited in claim 1, wherein the counter comprises a display used to display the number of times of the entrances of the optical storage medium into the recording/reproducing apparatus accumulated by the counter.

11. An optical recording/reproducing apparatus where an optical storage medium is directed into or moved away through an opening of the optical recording/reproducing apparatus, comprising:
a sensor used to sense each entrance of the optical storage medium into the optical recording/reproducing apparatus; and
a counter configured to count the number of times of the entrances of the optical storage medium into the recording/reproducing apparatus by accumulating the number of time of the entrances of the optical storage medium as sensed.

12. The optical recording/reproducing apparatus as recited in claim 11, wherein the optical recording/reproducing apparatus is a slot loading CD-ROM.

13. The optical recording/reproducing apparatus as recited in claim 12, wherein the slot loading CD-ROM comprises a roller used to move the optical storage medium contacted with the roller so that the optical storage medium is directed into the slot loading CD-ROM.

14. The optical recording/reproducing apparatus as recited in claim 13, wherein the sensor is used to sense the roller being driven and the counter is used to count the number of times of the entrances of the optical storage medium into the optical recording/reproducing apparatus by accumulating the number of times of being driven of the roller as sensed.

15. The optical recording/reproducing apparatus as recited in claim 13, wherein the slot loading CD-ROM further comprises a drive motor used to drive the roller to rotate and the counter counts the number of the entrances of the optical storage medium into the optical recording/reproducing apparatus by accumulating the number of times of being driven of the roller as sensed.

16. The counting device as recited in claim 11, wherein the optical recording/reproducing apparatus comprises an eject button used to move the optical storage medium away from the optical recording/reproducing apparatus upon being pressed.

17. The counting device as recited in claim 16, wherein the sensor is used to sense the eject button being pressed and the counter counts the number of times of entrances of the optical storage medium into the optical recording/reproducing apparatus by accumulating the number of times of the eject button being pressed as sensed.

18. The counting device as recited in claim 11, wherein the sensor is used to sense a switch and the counter counts the number of times of the entrances of the optical storage medium into the optical recording/reproducing apparatus by accumulating the number of times of the eject button being pressed as sensed.

19. The counting device as recited in claim 11, wherein the counter comprising a memory used to store the number of times of the entrances of the optical storage medium into the recording/reproducing apparatus accumulated by the counter.

20. The counting device as recited in claim 11, wherein the counter comprises a display used to display the number of times of the entrances of the optical storage medium into the recording/reproducing apparatus accumulated by the counter.
